(19) United States
(12) Patent Application Publication
(10) Pub. No.: US 2015/0106290 A1
(43) Pub. Date: Apr. 16, 2015

(54) METHODS AND SYSTEMS FOR ENHANCING STUDENT VISIBILITY DURING RECRUITING

(71) Applicant: GO GET RECRUITED, LLC, DRAPER, UT (US)

(72) Inventor: Scott M. Stevenson, Draper, UT (US)

(21) Appl. No.: 14/323,786

(22) Filed: Jul. 3, 2014

Related U.S. Application Data
(60) Provisional application No. 61/842,926, filed on Jul. 3, 2013.

(51) Int. Cl. G06Q 50/20; G06Q 10/00

(52) U.S. Cl. CPC G06Q 50/2053; G06Q 10/00
USPC 705/327

(57) ABSTRACT

Described herein are methods and systems for a third party to facilitate recruiting of a recruit by a potential recruiter and without acting as an intermediary. A processing device electronically provides recruiting information to a recruit. The recruiting information includes at least one of contact information for one or more potential recruiters or how-to information on preparing recruiting-related information to be sent to the one or more potential recruiters. The processing device provides a mobile application for download by the recruit. The mobile application includes capabilities for providing information regarding which of the one or more potential recruiters have viewed recruiting-related information of the recruit.

### CROSS-REFERENCE TO RELATED APPLICATIONS

This application claims the benefit of U.S. Provisional Application No. 61/842,926, filed Jul. 3, 2013, the entire contents of which are incorporated by reference herein.

### TECHNICAL FIELD

The present disclosure relates to marketing. More particularly, embodiments of the present disclosure relate to software, systems and methods for allowing students to market themselves to universities, colleges, schools, or others during a recruiting process. More particularly still, some aspects of the present disclosure include providing students with the tools to contact universities or others and provide relevant information to enhance their ability to obtain scholarships or other financial aid for participating in athletic, music, art, debate, or other programs.

### BACKGROUND

Recent estimations indicate that approximately 500,000 collegiate athletes are currently playing sports at the various levels of collegiate competition. While the majority of these athletes are part of the NCAA (e.g., approximately 420,000 combined between Divisions I, II and III), there are also significant numbers of athletes at the NAIA level (i.e., approximately 60,000) and the NJCAA or JUCO level (i.e., approximately 20,000). Consequently, over 100,000 student athletes are recruited each year to participate in the various levels of collegiate competition.

While almost all schools have some budget available to allow coaches of the various sports to go out and find and recruit talented student athletes for their programs, the reality is that there are simply too many high school athletes for any coach to evaluate to be able to find them all. This is particularly the case at smaller or lower-level schools that do not have the resources for a large recruiting budget or the manpower to visit many locations, spend countless hours calling high school and competition team coaches, tracking down highlight videos in the Internet, and the like. As a result, many students that could potentially play at some collegiate level are not discovered, or don't know that such an option may be available to them.

Other students may have the desire to play and may early-on start looking at ways to make themselves visible to coaches. Such students are often led to recruiting companies that sell students on their relationships with collegiate coaching staffs. It is not uncommon for a student to produce his or her own highlight video and then pay a recruiting company $5,000 or more to connect them with a suitable university. The student then hopes to receive a scholarship worth potentially five to thirty times that amount.

When using a recruiting company, the student is often cut out of much of the communication process with the schools. For instance, the student may provide the highlight video and pay the fee. The recruiting company may then take over and any emails, letters, phone calls, etc. to college coaches or athletic departments go out from the recruiting company. This simplifies the process for the student and the student's family, as well as for the high school or competition team coach. Unfortunately, however, the recruiting companies often make so much contact that they can overwhelm coaches and other recipients. This can contribute to many coaches dislike of recruiting companies and their tactics (e.g., suggesting they have “connections” to coaches and athletic departments). When the coaches receive these emails and messages from recruiting companies, they may therefore simply delete the communications. Money spent by students and their parents can therefore be wasted. Even more egregiously, some recruiting companies will receive a notice indicating when a coach “looked” at an email (e.g., a read receipt). The notice may simply be triggered by deletion of an email. Recruiting companies may therefore pass on to students information indicating that a coach looked at their correspondence, when in reality the coach only deleted an email without reading it or viewing the provided highlight video.

### SUMMARY

In accordance with aspects of the present disclosure, embodiments of methods, systems, software, computer-readable media, and the like are described or would be understood and which relate to marketing students and others. People may market themselves and their athletic, artistic, or other skills to a school (e.g., university, private school, etc.), a professional league, a company, or the like. The person may market themselves, and be in charge of all, or virtually all, communication with the school or other entity, thus providing direct contact and feedback on the progress of recruiting.

According to one or more aspects of the present disclosure, a method may be provided and relates to facilitating recruiting of a recruit by a recruiter. Optionally, a third party may perform the method without acting as an intermediary between the recruit and recruiter. In any such embodiment, recruiting information may be electronically provided to the recruit, and may include contact information for one or more potential recruiters and/or how-to information on preparing recruiting-related information to be sent to the one or more potential recruiters.

According to another aspect of the present disclosure, which aspect may be combined with any one or more other aspects herein, recruiting-related information can be hosted, and a recruit can be updated when potential recruiters view the recruit's information. In an example aspect, a service provider or third party separate from the recruit or potential recruit may track access of recruiting-related information of a recruit by one or more potential recruiters. The service provider may also notify the recruit of the access by the one or more potential recruiters.

According to another aspect of the present disclosure, which aspect may be combined with any one or more other aspects herein, a system may be used for facilitating self-recruiting activities by a recruit. An example system may include one or more processors and one or more computer-readable media communicatively linked to the one or more processors. The computer-readable media may include computer executable instructions for execution by the one or more processors to cause the system to perform a method relating to facilitating recruiting and/or hosting recruiting-related information.

According to another aspect of the present disclosure, which aspect may be combined with any one or more other aspects herein, personal recruiting-related information of a recruit may be stored.

According to another aspect of the present disclosure, which aspect may be combined with any one or more other aspects herein, an access link for accessing at least some personal recruiting-related information of a recruit may be provided.

According to another aspect of the present disclosure, which aspect may be combined with any one or more other aspects herein, a request to access at least some personal recruiting-related information accessible using an access link may be detected.

According to another aspect of the present disclosure, which aspect may be combined with any one or more other aspects herein, an origin of a request to access personal recruiting-related information may be detected.

According to another aspect of the present disclosure, which aspect may be combined with any one or more other aspects herein, a recruit can be notified of a detected request and an origin of the request.

According to another aspect of the present disclosure, which aspect may be combined with any one or more other aspects herein, recruiting-related information that is tracked may have been provided to the one or more potential recruiters by the recruit.

According to another aspect of the present disclosure, which aspect may be combined with any one or more other aspects herein, a mobile application may be provided to a recruit and/or used by a recruit.

According to another aspect of the present disclosure, which aspect may be combined with any one or more other aspects herein, a mobile application may include capabilities for providing information regarding which of the one or more potential recruiters have viewed recruiting-related information of the recruit.

According to another aspect of the present disclosure, which aspect may be combined with any one or more other aspects herein, a recruit may be authenticated.

According to another aspect of the present disclosure, which aspect may be combined with any one or more other aspects herein, recruiting-related information may be obtained from the recruit.

According to another aspect of the present disclosure, which aspect may be combined with any one or more other aspects herein, recruiting-related information may include any combination of one or more of physical characteristics, sports played, interests, scholastic information, or contact information.

According to another aspect of the present disclosure, which aspect may be combined with any one or more other aspects herein, recruiting-related information may include at least one highlight video.

According to another aspect of the present disclosure, which aspect may be combined with any one or more other aspects herein, a method, computer-readable media, or system may detect an amount or duration of recruiting-related information accessed, requested, or viewed by one or more potential recruiters.

According to another aspect of the present disclosure, which aspect may be combined with any one or more other aspects herein, a recruit may be notified of an amount or duration of recruiting-related information accessed, viewed, or requested by one or more potential recruiters.

According to another aspect of the present disclosure, which aspect may be combined with any one or more other aspects herein, a notification to a recruit may include sending an email to the recruit, sending a text message to the recruit, or providing an in-app message to a mobile application of the recruit.

According to another aspect of the present disclosure, which aspect may be combined with any one or more other aspects herein, a notification may be pushed to a recruit or may be provided in response to a pull request.

According to another aspect of the present disclosure, which aspect may be combined with any one or more other aspects herein, an access link may include any one or more of a web address, an IP address, a URL, a QR code, a snap tag, a MICROSOFT tag, a BLIPPAR image, or a SMARTSY image.

According to another aspect of the present disclosure, which aspect may be combined with any one or more other aspects herein, an access link may be provided to a recruit or potential recruiter via an electronic message, a letter, a highlight video storage device, or clothing.

According to another aspect of the present disclosure, which aspect may be combined with any one or more other aspects herein, an access link may direct a user to a resource or page specific to a particular recruit, a resource or page specific to a particular salesperson, or a home page for a provider of recruiting-related services.

According to another aspect of the present disclosure, which aspect may be combined with any one or more other aspects herein, video information may be received from a recruit.

According to another aspect of the present disclosure, which aspect may be combined with any one or more other aspects herein, video information received from a recruit may be used to create a highlight video.

According to another aspect of the present disclosure, which aspect may be combined with any one or more other aspects herein, a created highlight video may be provided to the recruit.

According to another aspect of the present disclosure, which aspect may be combined with any one or more other aspects herein, a recruit may send a highlight video to one or more potential recruiters.

According to another aspect of the present disclosure, which aspect may be combined with any one or more other aspects herein, sending a highlight video may include sending physical storage media including a copy of the highlight video, providing an access link specific to the created highlight video or a network-accessible resource that includes the highlight video, or uploading the highlight video to a personal web page of the recruit.

According to another aspect of the present disclosure, which aspect may be combined with any one or more other aspects herein, physical storage media that is sent and labeled for distribution to specific potential recruiters.

According to another aspect of the present disclosure, which aspect may be combined with any one or more other aspects herein, physical storage media may include an optical disk or solid state memory device.

According to another aspect of the present disclosure, which aspect may be combined with any one or more other aspects herein, providing a highlight video to a recruit may include providing pre-addressed packages or envelopes to the recruit for sending to one or more potential recruiters.

According to another aspect of the present disclosure, which aspect may be combined with any one or more other aspects herein, a number of physical storage media and/or pre-addressed packages or envelopes may correspond to a subscription or payment tier.

According to another aspect of the present disclosure, which aspect may be combined with any one or more other aspects herein, a request to access personal recruiting-related information may be tracked to identify a location.

According to another aspect of the present disclosure, which aspect may be combined with any one or more other aspects herein, a method, system, or computer-readable media may notify a recruit of a location or origin of one or more requests to access personal recruiting-related information of the recruit.

According to another aspect of the present disclosure, which aspect may be combined with any one or more other aspects herein, notifying a recruit of a location or origin may include pushing a notification to the recruit, providing an in-app message to the recruit, providing a map showing a location of one or more requests, sending information in response to a request of the recruit, providing a notice via a website, providing a notice via a text message, providing a notice via an email, providing a notice via a mobile application, or some combination thereof.

According to another aspect of the present disclosure, which aspect may be combined with any one or more other aspects herein, a potential recruiter may be a college or university.

According to another aspect of the present disclosure, which aspect may be combined with any one or more other aspects herein, activities for which the potential recruiter may recruit the recruit may include archery, art, badminton, baseball, basketball, biathlon, bobsled, bowling, boxing, cheerleading, canoeing, cricket, cross country, curling, cycling, dancing, debate, diving, equestrian, fencing, field hockey, football, golf, gymnastics, handball, ice hockey, kayaking, lacrosse, leadership, luge, martial arts, mixed martial arts, music, Nordic events, rowing, rugby, sailing, skiing, ski jumping, shooting, skating, skeleton, snowboarding, soccer, softball, swimming, table tennis, tennis, track and field, trampoline, triathlon, volleyball, water polo, weightlifting, wrestling, or other events, or any combination of the foregoing.

According to another aspect of the present disclosure, which aspect may be combined with any one or more other aspects herein, one or more computing systems may be included in a system, be used to perform a method, or process computer-readable media.

According to another aspect of the present disclosure, which aspect may be combined with any one or more other aspects herein, a website may be provided to allow recruits to purchase self-help recruiting services.

According to another aspect of the present disclosure, which aspect may be combined with any one or more other aspects herein, self-help recruiting services may include instructional information on how to produce a highlight video, recruiting rules and guidelines for universities and/or colleges, instructional information on packaging and mailing the highlight video to a recruiter, a database of potential recruiters, instructions for creating an online web page for hosting the highlight video, at least one sample introduction letter for sending to a recruiter, highlight video production, highlight video labeling, highlight video package addressing, or some combination of the foregoing.

According to another aspect of the present disclosure, which aspect may be combined with any one or more other aspects herein, multiple individual web pages may be provided which are specific to a particular recruit.

According to another aspect of the present disclosure, which aspect may be combined with any one or more other aspects herein, communication may occur with mobile devices of one or more recruits.

According to another aspect of the present disclosure, which aspect may be combined with any one or more other aspects herein, communication with a mobile device may occur through a mobile application capable of notifying a recruit when a recruiter accesses the web page specific to the recruit, notifying a recruit when a recruiter accesses a highlight video of the recruit, notifying a recruit of how long a recruiter accesses the web page or highlight video of the recruit, notifying a recruit of where an access request originated, or some combination of the foregoing.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a schematic illustration of an example communication system which may be used in connection with enhancing a person's visibility to a potential recruiter, in accordance with one embodiment of the present disclosure;

FIG. 2 illustrates an example method for enhancing a student's visibility and/or potential success in being recruited, according to one embodiment of the present disclosure;

FIG. 3 illustrates another example method for enhancing a student's visibility and/or success in being recruited, and includes tracking a recruiter's review of recruiting-related information for the student, in accordance with an embodiment of the present disclosure;

FIG. 4 illustrates an example method of tracking review of recruiting-related information, in accordance with an embodiment of the present disclosure;

FIGS. 5A-5K illustrate some example views of an electronic device that may be used to market a student to a school or other entity, and potentially track the progress of recruitment, according to an embodiment of the present disclosure;

FIGS. 6A-6D illustrate some example interfaces that may be displayed on an electronic device to market a student to a school or other entity, in accordance with another example embodiment of the present disclosure;

FIG. 7 illustrates an example location where materials may be accessed, in accordance with an embodiment of the present disclosure;

FIG. 8 illustrates an example shirt on which a QR code is displayed, in accordance with an embodiment of the present disclosure; and

FIG. 9 illustrates an example business card for a sales representative, in accordance with an embodiment of the present disclosure.

### DETAILED DESCRIPTION

Systems, methods, devices, software and computer-readable media according to the present disclosure may be configured for use in communicating information, including text, audio, video, or other information. Communication systems may be used to facilitate marketing of people to potential recruiters such as private schools, universities, professional athletic leagues, athletic team or event sponsors, and the like. People that may market themselves include, but are not limited to, student athletes. Indeed, embodiments of the present disclosure may be used for a variety of people and industries. By way of illustration only, students interested in music, art, debate, or other similar endeavors may also use embodiments of the present disclosure. Similarly, non-students interested in contacting a professional athletic team or league, an event organizer (e.g. the X-Games), or the like, may also use embodiments of the present disclosure to provide instructional information for a variety of purposes related to being recruited, identify potential recruiters, prepare videos or other recruiting-related information for recruiters, communicate with a recruiter, track communications with the recruiter, track activity of the recruiter when viewing videos or other recruiting-related information, or for other purposes, or any combination of the foregoing.

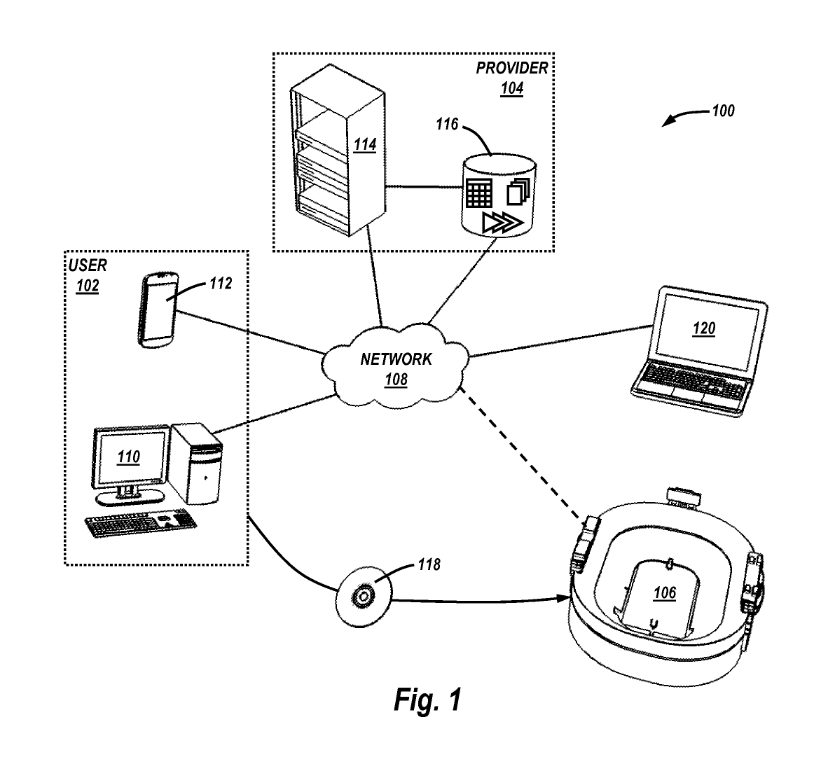

Turning now to FIG. 1, an example system is shown and includes a distributed system 100 usable in connection with embodiments of the present disclosure for sharing information, including information for enhancing a person's visibility to a potential recruiter. The distributed system 100 of FIG. 1 may include various entities, including a so-called “user” 102, a “provider” 104, and a “recruiter” 106. As used in reference to FIG. 1 and throughout this application, the term “user” is intended to encompass a person looking to be recruited. For instance, a student (e.g., a student athlete) may be a type of “user” 102 who contacts one or more universities, schools, colleges, etc. for the purpose of seeking a scholarship, a position on an athletic team, a position on in an academic group or team, or for other similar purposes. A university, school, college, or the like, including a specific team (e.g., basketball, football, track and field, soccer, cheerleading, etc.), activity (e.g., band, choir, debate, etc.), department (e.g., athletic department, fine arts department, etc.) may be some examples of a “recruiter” 106 as used herein. Of course, the present disclosure also contemplates other types of recruiters 106 and users 102, as will be appreciated by a person having ordinary skill in the art in view of the disclosure herein.

A so-called “provider” 104 as used in this disclosure may relate to a third party separate from users 102 and recruiters 106. In some embodiments, the provider 104 may be a facilitator who assists a user 102 in making himself or herself more visible to the recruiter 106 and/or enhancing the efficacy of communication between the user 102 and the recruiter 106. In accordance with at least some embodiments of the present disclosure, the provider 104 may be an invisible partner with the user 102. More particularly, the provider 104 may work with the user 102, but to the recruiter 106 it does not appear as though the provider 104 is involved. In other embodiments, the provider 104 may be involved to at least some extent. In at least some embodiments, the provider 104 is involved on a limited basis to facilitate electronic access of videos or other recruiting-related communications while the user 102 initiates and receives communications directly with the recruiter 106.

In the illustrated system 100, the operation of the system 100 may include a network 108 facilitating communication between one or more parties (e.g., the user 102, the provider 104, and optionally the recruiter 106). In at least some embodiments, the network 108 includes one or more electronic communication networks such as the Internet. In accordance with such embodiments, one or more electronic devices may be used by the various parties to communicate with each other via the network 108. While not intended to limit the present disclosure, the user 102 is shown as having access to two end-user devices 110, 112. The device 110 may generally represent one type of computing device (e.g., a desktop computer), while the device 112 optionally is a different type of device (e.g., a tablet computing device, a smart phone, an e-reader, etc.). Other types of devices may also be used, including laptop computing devices, personal media devices, or other devices, or any combination of the foregoing. Although not specifically illustrated, the recruiter 106 may also have one or more electronic devices usable to access the network 108.

In some embodiments, the provider 104 may include additional electronic devices capable of receiving information from, or providing information to, the user 102 and/or the recruiter 106 via the network 108. For instance, the provider 104 may also include personal, portable, or other electronic devices similar to those used by a user 102 and/or a recruiter 106. In other embodiments, additional or other electronic devices may be used. In FIG. 1, for instance, the provider 104 is shown as having a server 114 and a data store 116. Such devices may be used to store and/or execute various types of information or commands. For instance, as will be better understood in view of some later discussion herein, the provider 104 may store information such as tutorials (e.g., written, audio, video, etc.) on any of various subjects. Additional information may include compiled information on various recruiters (e.g., organizations/schools, names, addresses, phone numbers, email addresses, leagues/conferences/divisions, recruiting requirements, etc.). Still other information may include personal web pages for various users 102. In FIG. 1, the data store 116 is shown as including various types of information. Such information may instead, or additionally, be stored at the server 114, although in still other embodiments, the data store 116 may be part of the server 114.

In order to understand one embodiment in which the distributed system 100 may be used to market a user 102 to a recruiter 106, a more particular example is now described. It should be appreciated, however, that such an embodiment is merely illustrative, and is not intended to limit the scope of the present disclosure.

In one embodiment, the provider 104 may use the server 114, data store 116, other electronic devices, or some combination thereof, to provide an online resource for the users 102. In particular, the provider 104 may provide an online resource as a tool to be used by students to market themselves to a recruiter 106 such as a college coach. The online resource may be available through the network 108, and can include a website. Using the website, and optionally when logging in or otherwise authenticating with the website, providing payment for use of the website, etc., a user 102 may access various types of information. Video, audio, text, or other tutorials stored on the data store 116 may, for instance, be available. Such tutorials may provide information usable by the user 102 to learn information about the recruiting process and/or how to make the recruiting process more effective. Example types of tutorials or other recruiting-related information provided by the website or other resource may include: (a) how to make a highlight film; (b) how to find colleges and coaches; (c) how to find contact information for colleges and coaches; (d) how to draft a letter or email to a college coach to introduce yourself and express interest in the program; (e) how to effectively communicate with college coaches or other recruiters; (f) guidelines or rules for recruiting; (g) how to obtain academic clearance for the NCAA, NAIA, or NJCAA; (h) direct contact information for various coaches or other recruiters; (i) information on how to package/mail a highlight video to a recruiter; (j) other information; or (k) any combination of the foregoing.

Using this information, a user 102 (including family, friends, mentors, etc.) may begin a recruiting process. For instance, a student athlete user 102 may use information from the website to put together a highlight video, draft a letter to various college coaches, and the like. The highlight video may be stored on a DVD 118, Blu-ray disk, solid-state memory device (e.g., flash drive, SD card, etc.), or other type of computer-readable medium. Where the highlight video is stored on a tangible computer-readable medium, such as the DVD 118, the user 102 may then send the DVD 118 and/or other information directly to the recruiter 106. In one embodiment, the user 102 may mail or hand-deliver the information to the recruiter 106. In other embodiments, such as where video or other information is saved electronically, the user 102 may directly send an email to the recruiter 106. The email may include a highlight video as an attachment or include a link to the highlight video or other recruiting-related information. Any future correspondence may therefore be between the user 102 and the recruiter 106, without involving the provider 104.

While the user 102 may create the highlight video (e.g., on DVD 118), other embodiments may contemplate a third party producing the highlight video. For instance, a third party may use a computing device 120 to create the highlight video. Optionally, electronic copies of the highlight video are then provided to the user 102 who can produce the DVD 118 and/or send the video or links thereto to recruiters 106. In other embodiments, the third party may directly produce the DVD 118. In such an embodiment, rather than sending the DVD 118 from the third party user of the device 120 to the recruiter 106, the third party may provide the DVD 118 to the user 102, who then sends the video or other recruiting-related information to the recruiter 106 as if it has been produced by the user 102. In at least some embodiments, the third party user of the electronic device 120 may be the provider 104 or a party identified by the provider 104. For instance, for a basic fee, the user 102 may be able to access full self-recruitment information, including self-production of a highlight video. For a different fee, the provider 104 may produce the highlight video (or have it produced) and provide the video and/or DVDs 118 to the user 102. Where DVDs 118 are produced and sent to the user 102, the third party produce may also optionally provide other information (e.g., professional quality labeling, mailing envelopes, letters, etc.). The user 102 may thus have a full-service option where information is received in a form that can immediately (or almost immediately such as where a signature is first needed) be sent to a recruiter 106.

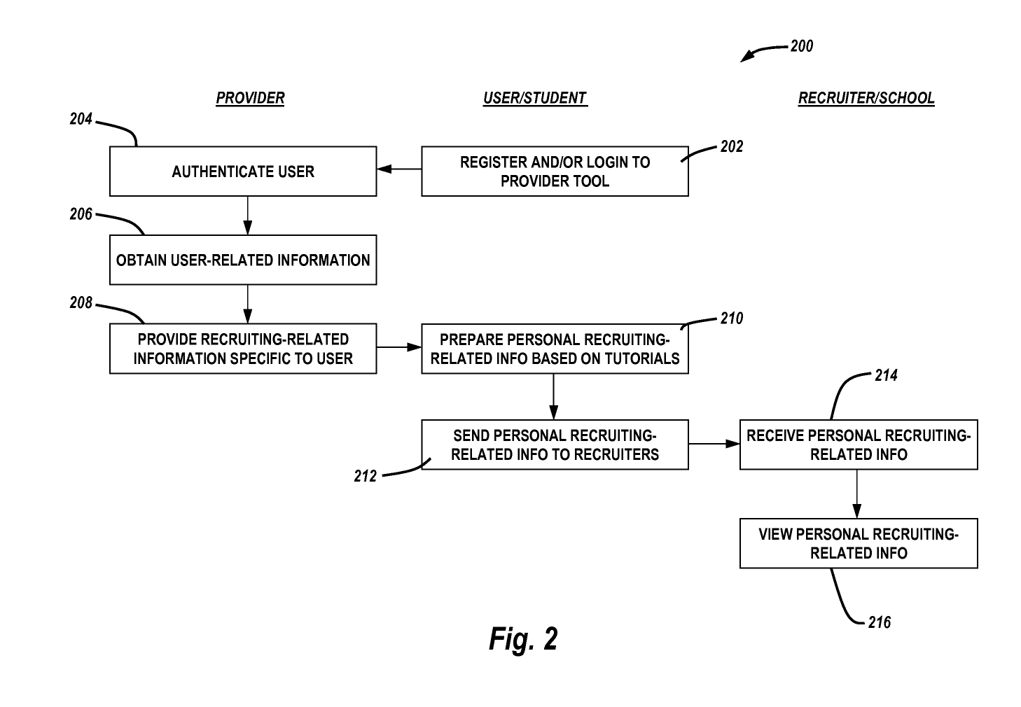

Turning now to FIG. 2, an example method 200 of enhancing a user/student's visibility to a recruiter, or the efficiency of communication with a recruiter, is displayed in additional detail. In particular, the method 200 may include use of a website, mobile application, or other network-accessible tool that is available to the user. In such an embodiment, the user may register and/or login to the provider's tool (act 202). Upon the user's creation of the account or provision of login information in act 202, the provider can authenticate the user (act 204). Authentication may include checking credentials (e.g., password, user name, device ID, etc.) for a previously created account, or creating a new account. When an account is created or accessed, the provider may also obtain user related information (act 206). In some embodiments, this information may be provided directly by the user. For instance, a questionnaire, survey, or the like can be presented. Information that is obtained may include the user's name, contact information, academic information (e.g., GPA, school, extra-curricular activities, SAT/ACT test scores, etc.), athletic information (e.g., sports of interest, positions, etc.), physical information (e.g., size, weight, etc.), or other information, or any combination of the foregoing.

Information provided by the user may be used in some embodiments to tailor or customize information presented by the website, application, or other tool. For instance, the provider may then provide recruiting-related information specific to the user (act 208). This information may include tutorial information as discussed herein. Other information may include information on recruiters for a specific academic or athletic event. For instance, if there were 1000 universities and colleges in the United States, but only 750 had recognized baseball teams, the recruiting-related information provided to the user in act 208 may include only the information on schools with baseball. If the user is only interested in, or would qualify for, certain classifications (e.g., NCAA, NAIA, NJCAA) or divisions, the information could also be similarly limited. Of course, in other embodiments, information on all potential recruiters may be provided, regardless of whether or not a particular sport, event, or the like is offered. Optionally, the listed information may include an identification of which sports or other events a school offers so that the user can filter through the information on his or her own.

The user may also take additional acts, such as shown in act 210. In this particular embodiment, the user may prepare personal recruiting-related information. Such information may include, for instance, one or more highlight videos of the user's participation in a particular sport or other event or activity. In some embodiments, the video may be prepared using information provided as tutorials. Such tutorials may be in any suitable format (e.g., written, audio, video, interactive, etc.), and may be provided by the provider. Optionally, the tutorials are included as recruiting-related information in act 208. Other personal recruiting-related information may also be produced in act 210, such as introduction letters/emails to a coach or other recruiter.

When the personal recruiting-related information (e.g., a highlight video, letter, email) is prepared, that information can be sent to a recruiter in act 212. In some embodiments, preparing the information in act 210 may include producing an electronic copy (e.g., an electronic video stored as a computer file) and/or a physical copy (e.g., a video on DVD, a tangible letter, etc.). An electronic copy may be sent directly by the user via one means, such as email, and can include the electronic information or a link thereto. A physical copy can be sent by mail, courier, or personal delivery and can include the same information and/or instructions or other elements for use in accessing the information (e.g., a URL or web address, launch points to an online video using technology such as QR codes, snap tags, MICROSOFT tags, BLIPPAR, SMARTSY, or the like, etc.). Thereafter, the recruiter can receive the information in act 214 and view the information in act 216. If interested in the user, the recruiter can then follow-up by making contact with the user, a coach, parent, or teacher of the user, or in some other manner. In other embodiments, certain acts of the method 200 may be repeated. For instance, a user may send recruiting information to the recruiter 214 multiple times, and potentially in different formats. The user may also follow-up with the recruiter one or more times.

One aspect of the method 200 of FIG. 2 is that although the provider may be involved in the method 200, the provider can effectively be invisible to the recruiter. Indeed, as all communication with the recruiter may be initiated by, or with, the student or other user, the provider can help the user get himself or herself recruited. This can reduce the sometimes false beliefs of students or other users that a particular service provider has pre-established relationships with schools or other recruiters. Moreover, this allows students and other users to personally indicate they are interested in, and have researched, a particular school so that a recruiter can know the student truly is interested, and is not simply part of a mass-mailing to many schools. A coach can therefore immediately recognize the communication as being from the student himself or herself, determine that there is genuine interest, and respond by looking at the student.

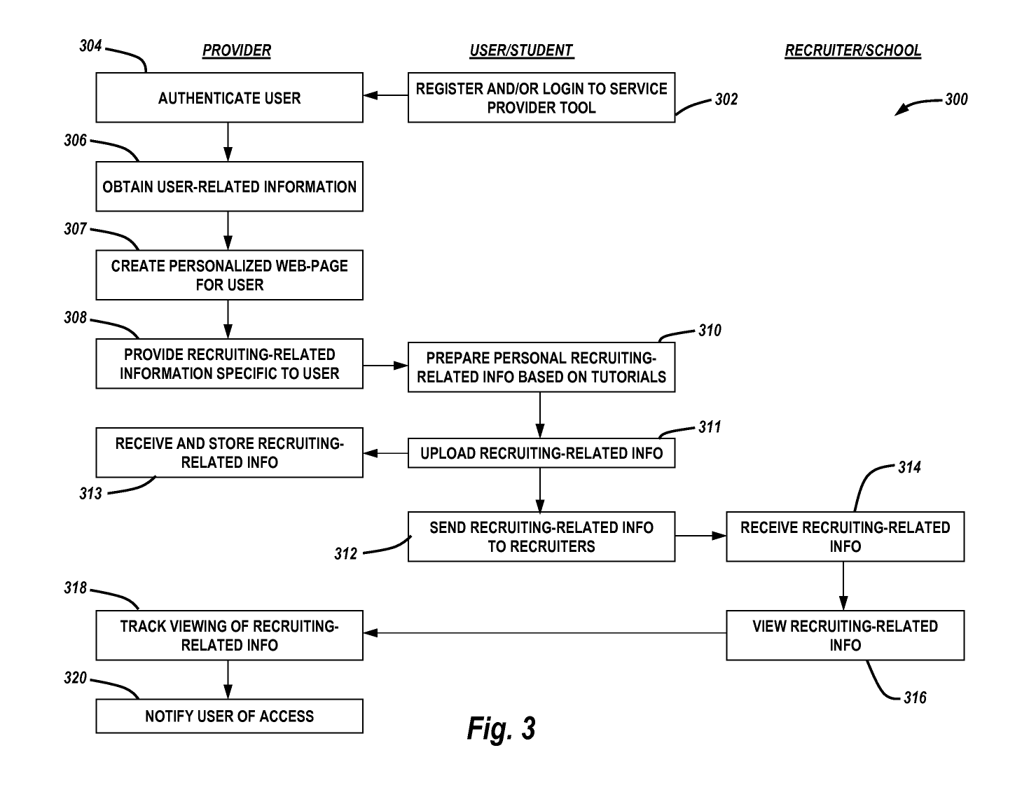

Turning now to FIG. 3, a method 300 is illustrated and described. In particular, the method 300 is similar in some regards to the method 200; however, additional optional acts may be performed. In particular, a user may register and/or login to a service provider's tool in act 302, and the provider may authenticate the user (act 304) and obtain user-related information (act 306). Such acts may be similar to corresponding acts in method 200 of FIG. 2.

In this embodiment, however, the method 300 may include the provider creating a personalized web-page or other location for the user (act 307). The personalized web page may be viewable by the user only, or in other embodiments may be publicly accessible. For instance, a web page may be created which includes highlight videos, academic and athletic information, contact information, and the like for a particular student. Such information may include some or all of the information obtained in act 306 and/or in other parts of the method 300. Optionally, the web page may be created to appear as a stand-alone web page rather than part of a searchable database, so that knowledge of the provider's involvement can be limited or unknown.

A user may also be provided with recruiting related information (act 308), such as tutorials, links to recruiters (e.g., schools, universities, colleges, etc.), contact information for recruiters, instructions or examples of introduction letters/emails, and the like, or any combination of the foregoing. Using such information, a user may prepare personal recruiting-related information (act 310). Optionally, the user may upload that information (act 311) to the provider. The provider may then receive and store the information (act 313). Optionally, some or all of the information uploaded in act 311 can be included as part of the web page or other resource created in act 307. Such information may include text (e.g., letters/emails from the student or coaches, descriptions of academic/athletic skills or achievements, highlight videos, and the like).

A user may also send prepared personal recruiting-related information directly to a recruiter in act 312. As discussed herein, such information may be sent electronically or physically. Optionally, sent electronic or electronic information may include a link or other information for accessing the personalized web page created in act 307. The recruiter may then receive the information (act 314) and potentially view the information (act 316). Viewing the information may include viewing information directly received, as well as accessing information referenced (e.g., a web page with a highlight video). In an embodiment where viewing the information in act 316 includes accessing referenced material, or accessing electronic information, such as web page, viewing of the information by the recruiter can optionally be tracked (act 318). For instance, a provider 318 may host the personalized web page and track who accesses/views information, where the information was accessed/viewed, when it is accessed/viewed, how long a person accesses/views the information, and the like. Notifications of access, and potentially additional information about who, where, when, and how long may also be given to the user (act 320).

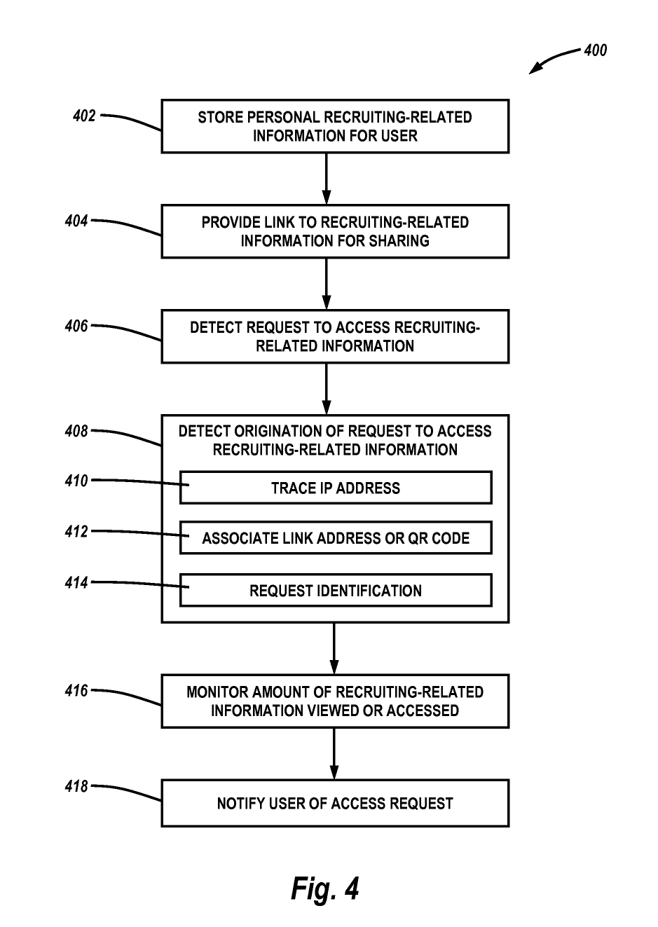

Tracking viewing of information provided to a recruiter may be done in any number of forms, as may the notifying of the user of such access. FIG. 4, for instance, illustrates an example method 400 for tracking access and viewing of personal recruiting-related information of a particular user. In this method, the personal recruiting-related information of a user may be stored in act 402. A link, address, or the like may be provided to allow the recruiting-related information to be shared. Such a link may take any suitable form, including a text URL address for a link in the form of a web page address, text providing an electronic address linking to a media file, a QR code linking to particular web page or media file, a snap tag or MICROSOFT tag linking to a particular web page or media file, an image associated with BLIPPAR or SMARTSY, or in other manners.

The method 400 may further include detecting when access to the recruiting-related information is requested (act 406). For instance, if a recruiter clicks on a link, types in an address, scans a QR code, MICROSOFT tag, or snap tag, captures an image for BLIPPAR or SMARTSY, or takes some other action, it may take the recruiter to a web page that includes a highlight video of a particular user. That attempt to access the web page and/or video may be detected in act 406. Optionally, such detection may be wholly independent of detecting when a communication is received, opened, or deleted by a recruiter. Indeed, in some embodiments, a user may send introductory, highlight, or other materials to a recruiter, and potentially without involving a third party (e.g., a provider). Detecting a request to access information in act 406 may be done by the provider, and may therefore be separate from the acts of sending information to the recruiter.

Optionally, detecting access requests in act 406 may include storing some information associated with the request. For instance, the number of times a request is made, the time a request is made, and the like may be stored. In additional embodiments, the origin of a request may be detected (step 408). Such an act may be performed using any number of techniques. For instance, when an electronic file accessible over the Internet or another network is accessed, an IP or other similar address of a requesting electronic device may be obtained. The IP address may then be traced to identify an institution, geographic location, or the like with which it is associated. For instance, the IP address 130.184.12.132 may be traced to the city of Fayetteville, Ark. Further, the ISP associated with such an address may be identified as the University of Arkansas. Thus, if the IP address 130.184.12.132 is used to request access to recruiting information, it may be determined (e.g., by a provider) that someone at the University of Arkansas has accessed the information. If recruiting information was sent to the University of Arkansas, it could be determined that the communication therefore was delivered and desired information was accessed.

In other embodiments, the origin of an access request may be detected in additional or other ways. For instance, if a link address, QR code, or other launch point is provided to allow a recruiter to access information, the link, QR code, or other launch point (e.g., snap tag, MICROSOFT tag, BLIPPAR or SMARTSY image, etc.) may be customized for a particular recruiter. In such case the step 408 may include associating a link, QR code, launch point indicator, or other similar device with a particular origin (e.g., a particular recruiter). As an example, the link http://www.joseph.slater.myhighlights.me may be for a personalized web-page for a user named Joseph Slater. Using that link, a recruiter may access a personalized web-page, including any highlight videos, resume information, and the like that may be on the page.

When determining who to send the information to, the user and/or provider may, however, also create personalized links for each recruiter. A link such as http://www.joseph.slater.myhighlights.me&qrt45ez may direct a recruiter to the same page as the prior link. The “qrt45ez” appended to the link may, however, be associated with a particular recruiter. Thus, when that link is used, the method 400 may identify a particular recruiter as making the request. Similarly, the link http://www.joseph.slater.myhighlights.me&8h72ynp may go to the same web page, but can identify still a different recruiter. Thus, although the same information may be accessed, the form of the address, link or other launch point (e.g., QR code, snap tag, MICROSOFT tag, BLIPPAR image, SMARTSY image, etc.) may be used to identify the origin. Of course, in still other embodiments, a person requesting information may be asked to identify who they are (act 414). In still other embodiments, other methods or acts may be used to detect the origin of an access request in step 408. For instance, a DVD, Blu-Ray disk, flash drive, or other medium on which a highlight video or other information is provided may include embedded software that triggers an electronic notification. The notification may identify the disk, location of access, or other information to enable a determination of where the information was accessed (or by whom it was accessed). Any other method of detecting an origin of an access request may also be used in step 408.

In addition to, or instead of, detecting an origin of an access request in step 408, some embodiments contemplate monitoring an amount of recruiting-related information viewed or accessed (act 416). For instance, if there are multiple pages of textual information, the act 416 can track which pages were accessed, how long each was accessed, and the like. Similarly, a video highlight may be accessed. The time when viewing began, the time the viewing ended, the amount streamed, and the like may be monitored in act 416 to get an idea of what parts and what portion of available information was actually viewed. Thereafter, a user may be notified in act 418 of the access. In some embodiments, notifying the user of access requests in act 418 may include providing additional information such as when an access request was received, the origin of the access request, how much of the information was accessed or viewed, how long information was viewed, how many times access was requested, and the like. Some or all portions of the method 400 may thus also be iterative and/or cumulative. For instance, each time a particular location accesses the information, an additional count can be added to the number of times accessed by a particular location. The total time accessed and/or portions accessed can also be updated each time and/or each access may be individually identified.

The user may be notified in act 418 in any number of manners. For instance, a text message, email, phone call, or other notification can be triggered automatically upon completion of an access request, and can include information as described above. Alternatively, information may be stored so as to be accessible by a user upon request. For instance, when using a mobile application, web page, or the like, a user can access stored information to see a list and/or map indicating when information was accessed, by whom or where it was accessed, how long it was accessed, what portions were accessed, and the like.

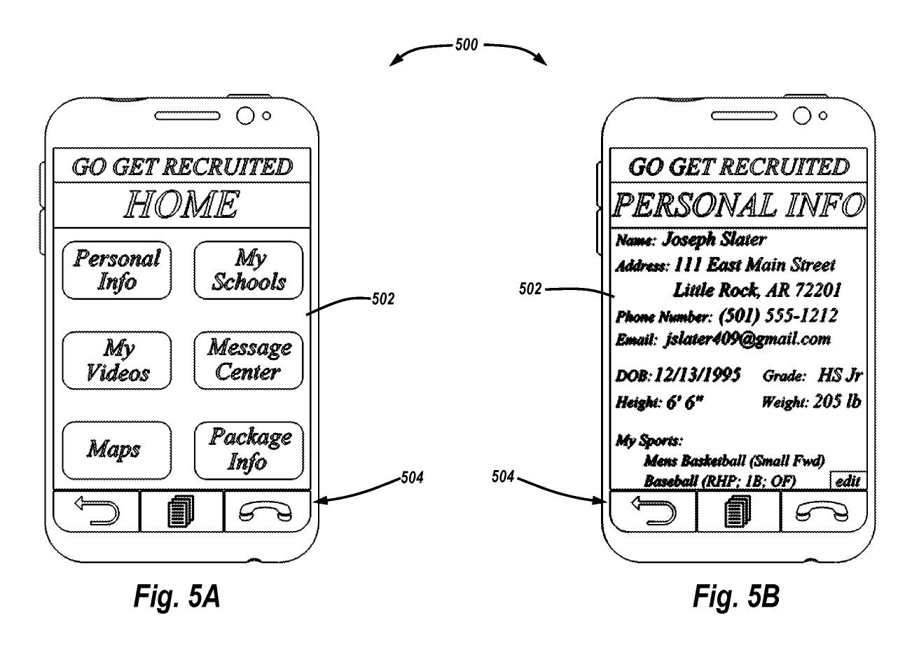

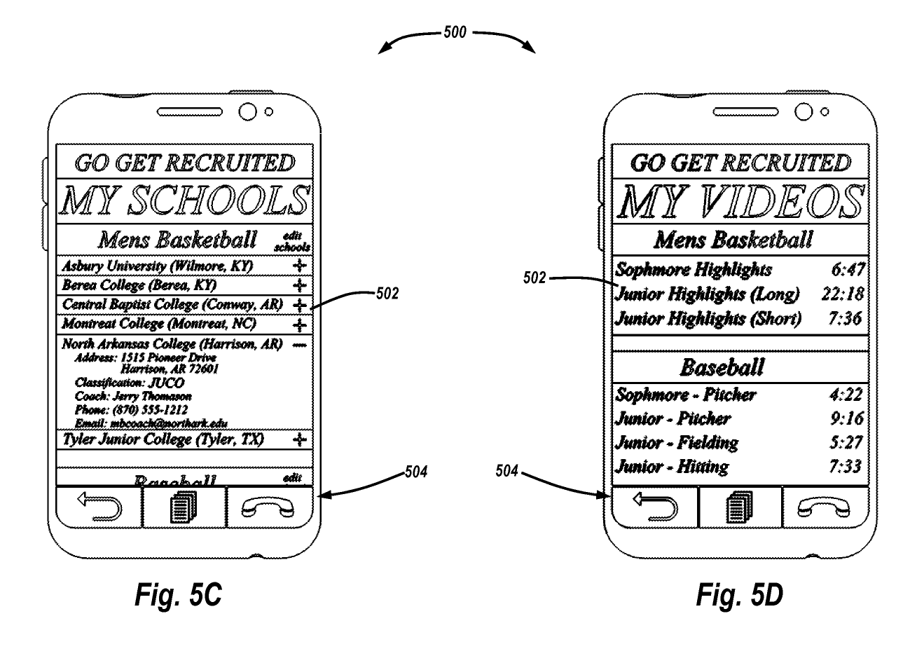

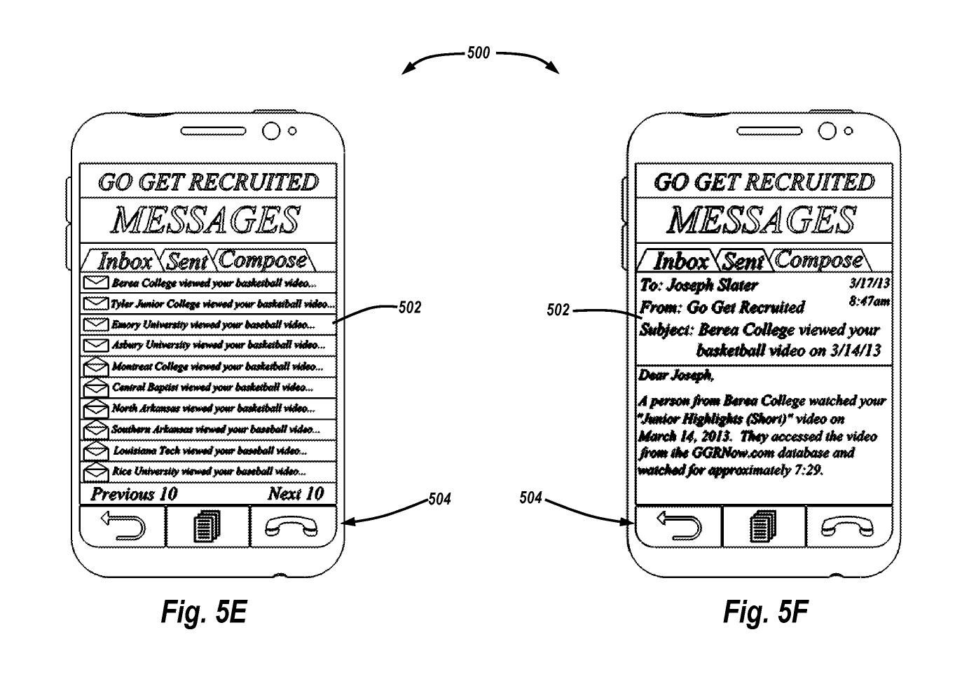

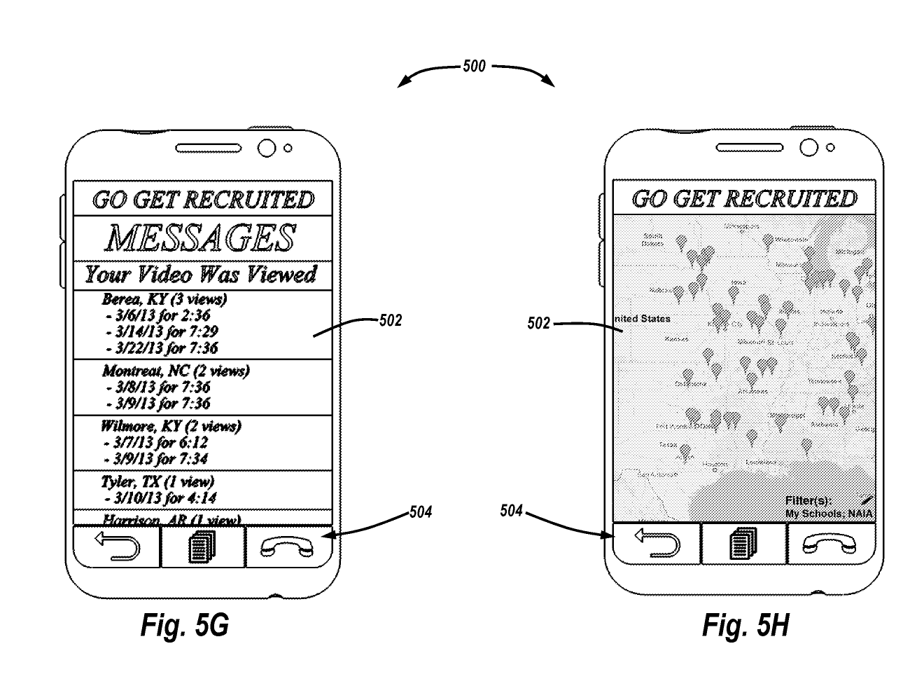

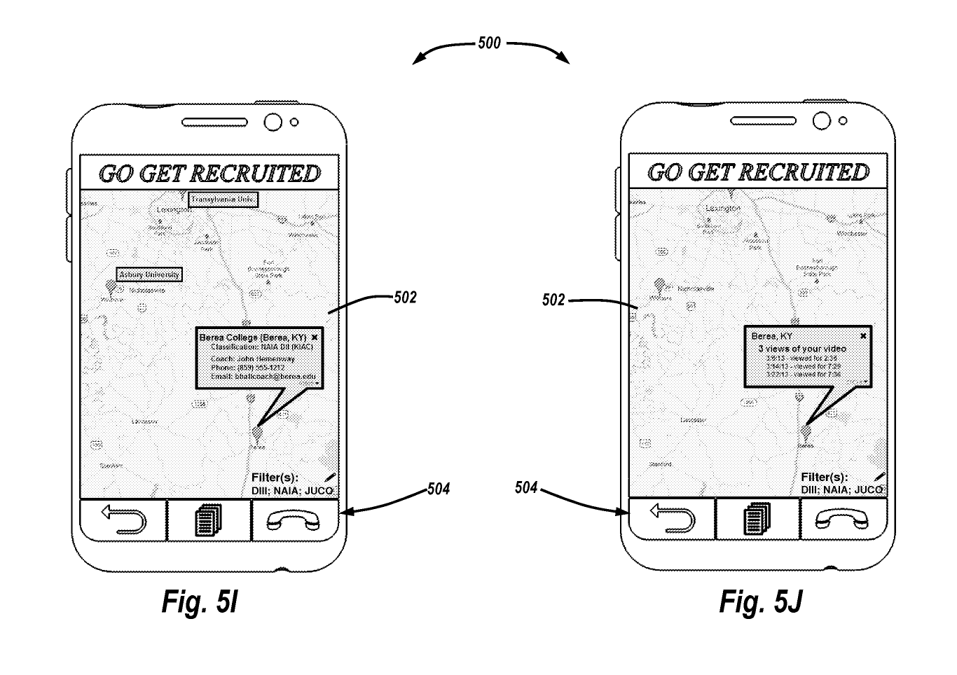

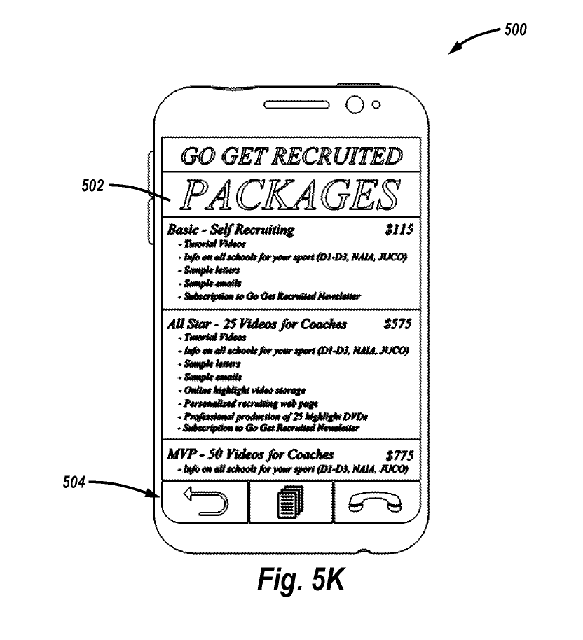

Turning now to FIGS. 5A-5K, embodiments of methods, systems, devices, computer-readable media, and interfaces for providing information to a recruitable user, and optionally notifying a user of accesses to recruiting materials, is shown in some detail. It should be appreciated that the embodiment of FIGS. 5A-5K is, however, merely illustrative and should in no means limit or restrict the manners in which information can be provided or viewed, or be used to require that any embodiment include any feature disclosed in FIGS. 5A-5K.

More particularly, FIG. 5A illustrates an example computing device 500. The illustrated computing device 500 includes a display 502 and various input controls 504. The input controls 504 may take the form of buttons, but may have other forms, including touch-sensitive capabilities on the display 502. In some embodiments, the computing device 500 may include a mobile device such as a mobile phone, a smart phone, a tablet computing device, an e-reader, a personal media player, or the like. In such embodiments, information displayed on the display 502 may be provided using a mobile application, browser, other component, or some combination of the foregoing. In other embodiments, the computing device 500 may be a computing device such as a desktop computer, laptop, netbook, or the like. Such a device may also display information using an application, a browser, or other component, or any combination thereof.

FIG. 5A may illustrate a particular view of an interface (e.g., a mobile application) through which a user can view information related to his or her recruitment for any number of athletic, academic, or other activities. For instance, the interface may include an option to input personal information. Using such an option, a user can provide certain information. FIG. 5B illustrates a particular, non-limiting example, in which contact information (e.g., name, address, phone number, email, etc.) may be provided. Other personal information may also, or alternatively, be provided. FIG. 5B illustrates example information such as a date of birth or age, grade in school, height, and weight. Information about activities for which recruiting is desired may also be provided. Information may be related to athletic activities and sports, academic activities, artistic endeavors, and the like. Other information may also be provided, including academic transcripts or information, coach or mentor names and contact information, parent information, demographic information, and the like.

In some embodiments, the interface displayed on the electronic device 500 may be used to find, identify, or select recruiters to contact. FIG. 5A, for instance, includes a “My Schools” option. Using such an option, the user may be able to view a list of schools or other recruiters to potentially contact, filter the results by relevant criteria (e.g., location, classification, enrollment, participation in a particular activity, availability of scholarships, etc.). In some embodiments, a user may even select certain schools. FIG. 5C, for instance, illustrates an example embodiment in which six schools have been identified as possible recruiters for the user's basketball skills. The same or other schools may be listed for other skills (e.g., baseball in this embodiment). The listed schools may be modified at any time. This embodiment, for instance, includes an “edit schools” option to allow additional schools to be included, schools to be removed, or the like.

Listed schools or other recruiters may also have any number of different types of information listed. FIG. 5C, for instance, provides an illustration of an optional expandable format in which schools and location may be displayed, along with other information. Such other information may include information such as an address for visiting the recruiter or sending recruiting-related materials. Information about a classification (e.g., NCAA, NAIA, or NJCAA/JUCO) or division (e.g., FBS, FCS, Division I, Division II, Division III, etc.) may also be provided. Other information may include names of relevant contacts (e.g., coaches, recruiters, athletic directors, etc.) and any specific phone numbers, email addresses, or other contact information for those people). Of course, such information is merely illustrative. Other information may also or alternatively be listed, including recruiting restrictions or rules, school enrollment, an identification of number of available scholarships, and the like.

In some embodiments, a user may prepare certain materials to send or provide to a recruiter in order to make an introduction or induce interest on the part of the recruiter. Letters, emails, and highlight videos are but some examples of types of materials that may be provided. In FIG. 5A, a list of highlight videos may be selected using the “My Videos” option. FIG. 5D then shows an example interface listing the various videos the user prepared, had prepared for him or her, or the like. In this embodiment, each video name and duration is shown, although other information (e.g., date created, who created it, file size, etc.) may be provided. Optionally, selecting a particular video may allow a user to view a video, or potentially see what recruiters or others may have accessed a video. Optionally, the interface in FIG. 5D may also be used to edit the videos, add or remove videos, or the like.

FIG. 5A further illustrates an option to view messages, and FIGS. 5E and 5F illustrate example interfaces for viewing and/or creating messages. Such messages may take any number of forms. For instance, the messages may tie-in to an existing email or text message account for a user, to display third party information. Information sent through the interface may therefore also be sent as if originating directly from an account, rather than from application, web page, or the like originating from, or managed by, a service provider. Thus, a user could send an email to a recruiter directly through the interface in FIGS. 5A-5K, and monitor any responses.

In some embodiments, as discussed herein, a user may be notified when a recruiter accesses recruiting information. The interfaces of FIGS. 5A-5K may therefore also be used to not only monitor direct correspondence with a recruiter, but any access a recruiter makes of some or all recruiting materials. For instance, if a highlight video is hosted online, each time someone accesses the video, a notification may be displayed to indicate when, who, or where the access request was made. FIG. 5E, for instance, illustrates that each access request may result in a notification. Other information such as how long access lasted, or how much of available materials were accessed, could also be displayed. FIG. 5F for instance, illustrates an option where a notification indicates that a particular school be identified as accessing materials for a period of time. Of course, information about how many total times that school or location has accessed information, individual and/or cumulative view times, and the like can also be provided.

Notifications or messages may also be provided in other manners. FIG. 5G, for instance, illustrates a view that may be provided for a specific video. The messages show that access requests have originated from at least five different locations. One location viewed the video three times, two have viewed the video twice, and another two viewed the video once. There may also be more access requests which could be available by, for instance, scrolling down on the display 502. The illustrated message center in FIG. 5G may also provide information beyond how many times each location has requested access, such as when each access request occurred, how long access lasted, and the like. Other information may include an association of a location to a particular recruiter, a cumulative view time, whether any correspondence or follow-up has been received from that location, or other information.

Returning to FIG. 5A, another embodiment contemplates providing a map to display any of a number of different types of information. FIG. 5H, for instance, displays one map in which various locations are marked. The locations marked may correspond to individual recruiters, and optionally are filtered based on one or more criteria. FIG. 5H, for instance, illustrates that the filter criteria indicates only those recruiters that are part of “My Schools” and have an NAIA classification should be displayed. Of course, other filters may also be provided. Such filters may include filters to show all potential recruiters, recruiters of other classifications (NCAA, Division I, Division II, Division III, FCS, FBS, NJCAA/JUCO, etc.), recruiters within a limited region (e.g., state, time zone, conference, country, etc.), recruiters who have responded to recruiting information, recruiters who have not responded to recruiting information, recruiters who have viewed recruiting information, locations where recruiting information has been viewed, and the like.

Optionally, the map view of FIG. 5H may be used to obtain information about a particular location or recruiter. FIG. 5I, for instance, illustrates a view in which the map of FIG. 5H has been zoomed in. The filters have been changed to illustrate all Division III, NAIA, and JUCO recruiters. Optionally, the listed recruiters may be implicitly limited to participation in particular events already specified by a user, or a filter may expressly be used. In this embodiment, three recruiters are listed. When selecting one recruiter, additional information may be provided to get information such as location, classification, and coach contact information. Other information could of course also be provided, including other information discussed herein, such as address information, admissions requirements, enrollment, and the like. As further shown in FIG. 5J, still other information could also be provided. For instance, the information may show where access to recruiting-related materials has occurred. In this particular embodiment, three access requests may have originated from Berea, Ky. The total duration or percent accessed, information on each individual request, or the like may also be displayed. Other information, such as the originating IP address, could also be provided.

The application, web page, or other interface of FIGS. 5A-5J could also be used for other purposes. For instance, as discussed herein, individual links, QR codes, snap tags, MICROSOFT tags, images associated with BLIPPAR and/or SMARTSY, and the like could be generated in order to track who accesses certain recruiting-related materials. The interface on the device 500 could also include a feature for generating such a link, code, or the like for each recruiter. Further, as shown in FIG. 5A, the interface may provide different access or service options. If different packages are available for purchase, the “Package Info” option could be used to show what package a user has selected or purchased. Optionally, the same option may be used to obtain information on other packages to purchase or upgrade packages. FIG. 5K illustrates a particular example in which various packages are shown, and in which still other packages may be available by scrolling on the display 502. The packages may show information such as the cost and what features or services are included. Optionally, a packages is selectable for additional details and/or for purchase.

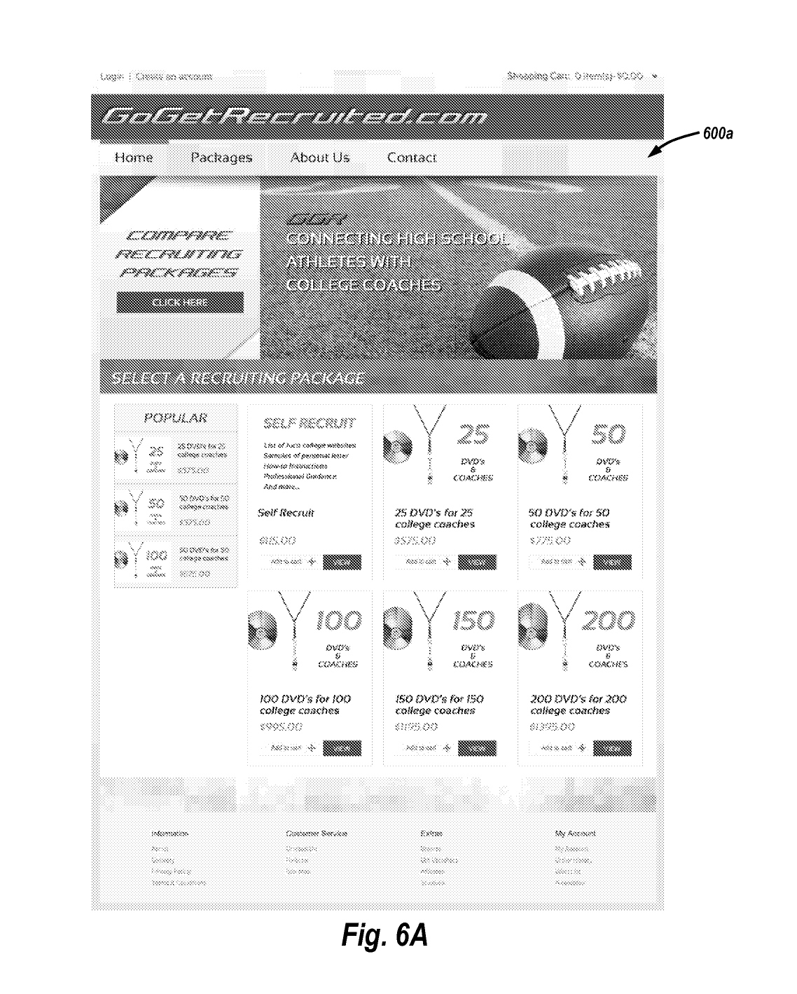

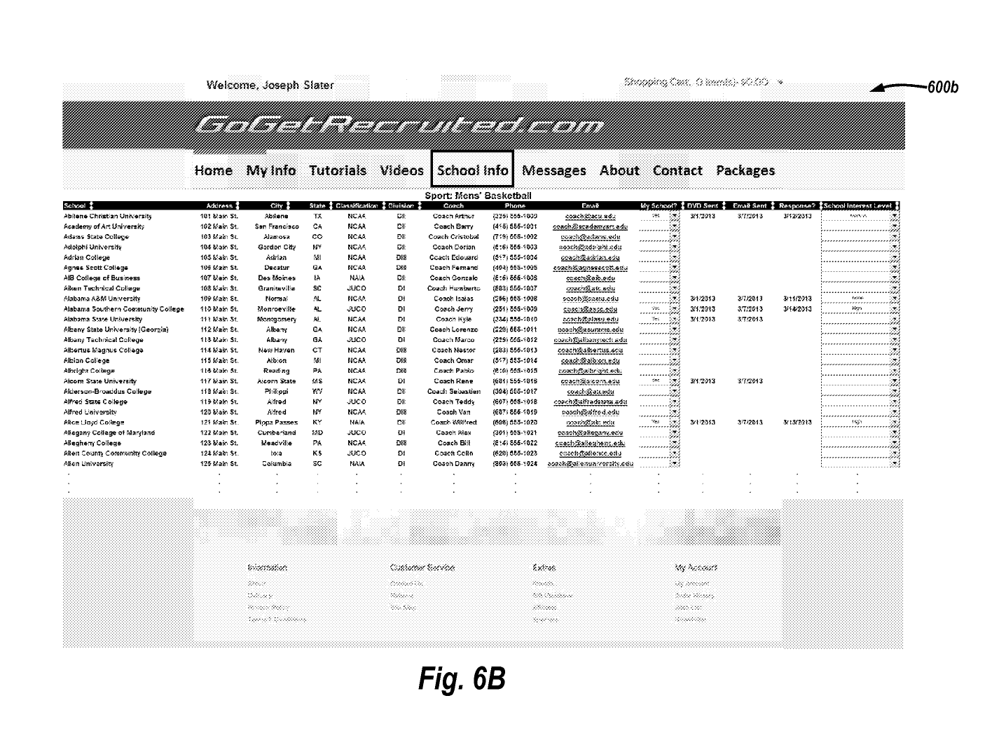

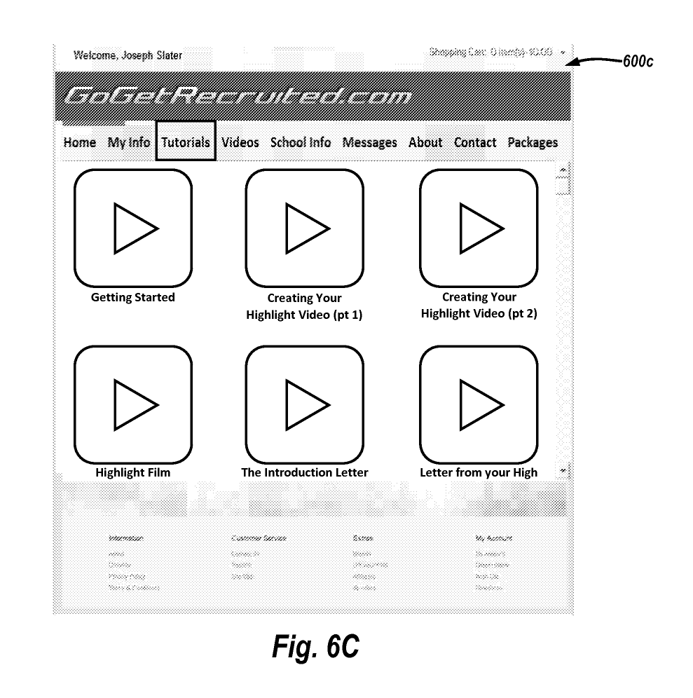

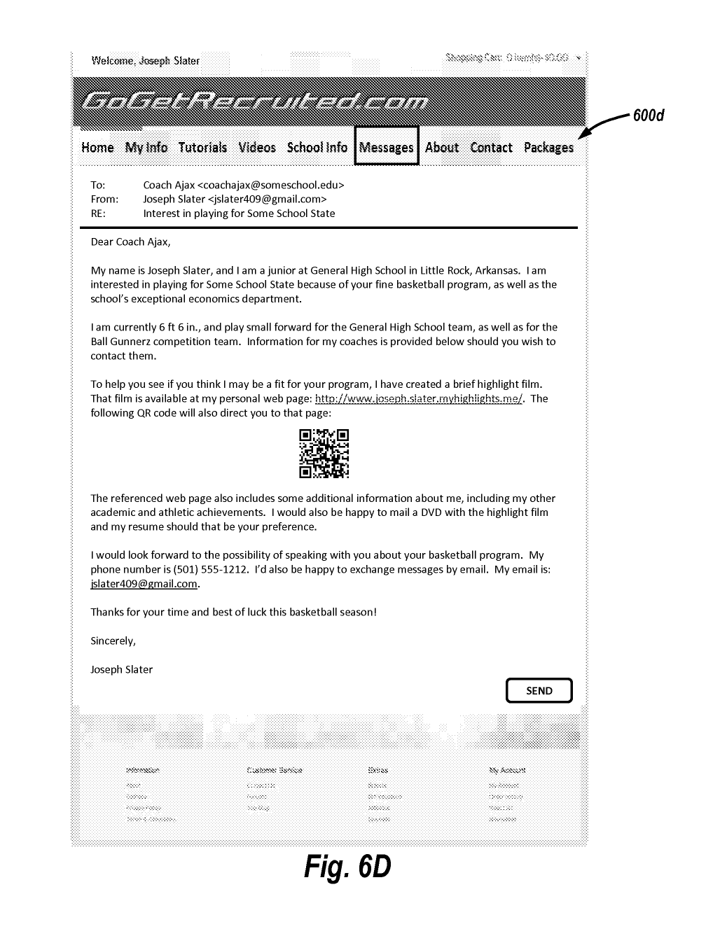

As discussed herein, the interfaces of FIGS. 5A-5K are merely illustrative and are not intended to limit the scope of the disclosure to any particular form. FIG. 6A, for instance, illustrates yet another interface 600 that may be displayed on an electronic device (e.g., smart phone, tablet, desktop, laptop, etc.). This interface provides information similar to that of FIG. 5K about different recruiting packages that may be available. For instance, a self-recruiting package may be provided to allow a user to get instructions and tutorials on how to create their own highlight video, find schools where they may be a fit, and prepare materials for contacting the school. Contact information for the various schools may also be provided. Other packages, however, may include other or additional features. For instance, other packages may allow the user to request that the provider or a third party prepare the highlight video. Such packages optionally include provision to the user of various numbers of physical DVDs or other copies of the produced highlight video. Each package may be separate, or packages may be purchased a la carte.

As discussed herein, one aspect of some embodiments of the present disclosure may include providing a user with a list of schools or other recruiters which they may potentially contact. FIG. 6B illustrates an example interface 600b in which a list of various schools is shown. The list may include various types of information, including the name of a school or other recruiter, the location, the athletic classification/division, the name of a coach for a relevant activity, that coach's phone number and email address, and the like. The list may also be dynamic and editable by the user. For instance, a user may select schools or recruiters that may interest him or her. Other information may be provided to indicate when a user mailed/emailed correspondence to the school (e.g., first time, second time, etc.). Each time a school responded, contacted a coach, sent a scholarship offer, or the like could be included. A user could also indicate his or her interest level, or the level of interest it appears that a particular school may have. The list can be sorted, filtered, or otherwise manipulated to provide only the relevant data desired by a user. Thus, a list may include very college in the United States and/or Canada, but can then be filtered based on location, interest level, enrollment, classification/division, and the like. The list may also be provided in various formats, including a downloadable, mobile, cloud-based, or other format.

FIGS. 6C and 6D illustrate still other potential interfaces that may be provided. FIG. 6C, for instance, illustrates that various video tutorials may be provided to a registered user. Such tutorials may cover any number of different topics. Example topics may include how to produce a highlight video, how to draft a letter/email to a coach, how to find relevant recruiters, how to package recruiting materials, how to prepare your high school/competition team coach, an introduction to rules/regulations of different collegiate classifications, how to obtain academic approval, and the like.

As discussed herein, a user can directly control his or her contact with a school or other recruiter. A user may therefore draft a letter/email and send it without a provider even being aware that such correspondence has occurred. Optionally, however, the contact may be initiated by the user but available to the provider. FIG. 6D, for instance, illustrates an example where an interface 600d ties into the email address of the user. The interface 600d may optionally be used to draft and send an email to the potential recruiter. By tying into the user's own email address, however, the message looks to originate from the user without the involvement of the provider of the interface 600d.

As also shown in FIG. 6D, an optional embodiment contemplates including a link to a network-accessible location to allow the recipient of the message (i.e., the recruiter) to view available highlight videos, personal information, achievements, and the like. The link may be provided in any number of manners. For instance, a link may be provided as text with an optional hyperlink as shown in FIG. 6D. Additionally, or alternatively, the link may include other formats. An example other format may include a launch point in the form of a QR code, snap tag, MICROSOFT tag, BLIPPAR or SMARTSY image, or the like. In the example of a QR code or other launch point, the provided launch point can be a dynamic or static link to a particular web page, including the web page at the address shown in FIG. 6D. By scanning, capturing, or otherwise using the QR code or other launch point, a recipient recruiter's computing device can automatically navigate to the location of available recruiting information.

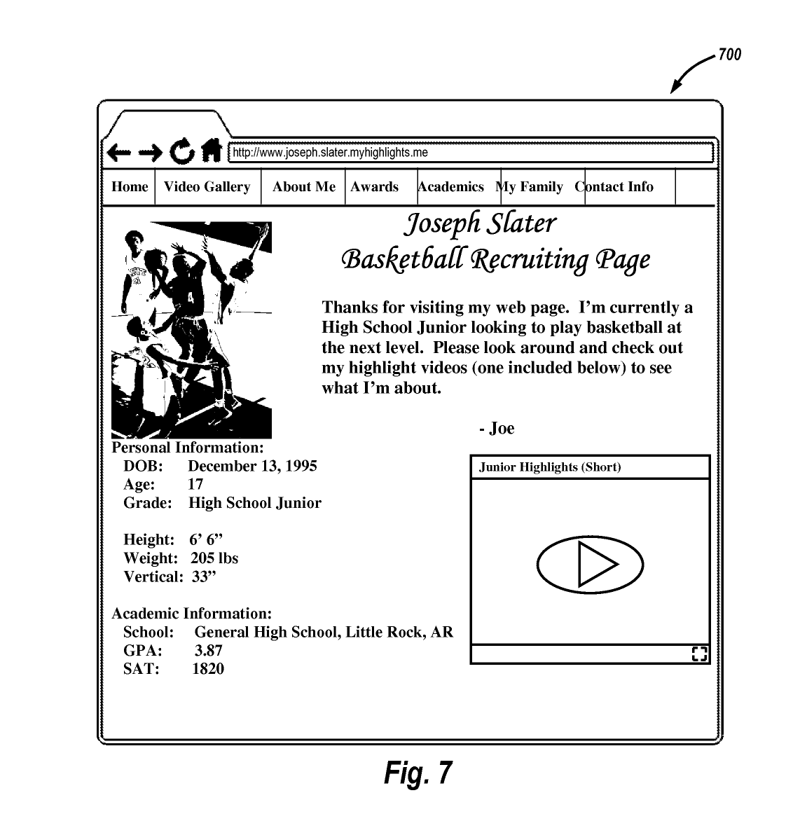

An example location where such materials may be accessed is shown in FIG. 7. In this particular embodiment, a customized web page 700 may be provided for accessing a user's information. Optionally, the customized web page 700 may be the same or similar to that produced in method 300 of FIG. 3.

As shown in FIG. 7, the web page 700 may include any number of different types of information. For instance, the web page 700 includes an introduction, pictures, a highlight video, personal information, and academic information on the home page. Other tabs or pages may also be provided. In this particular example, additional pages may include a video gallery, more information about the player/user, awards the player has received, additional academic information (e.g., classes taken, course interests, extra-curricular activities, etc.), information about the player's family, contact information, and the like. Still other information could be provided. Example additional information could include a picture gallery, news articles about the player, information about teams and coaches of the player, box scores of games, and the like.

In some embodiments, the web page 700 may be automatically generated based on information provided by the user. According to one or more embodiments, multiple templates may be available to allow the user to select a particular style of a web page, and potentially even customize the web page manually. For instance, a user could select fonts, colors, page categories, and the like. The user could also select which content to provide.

Embodiments of the present disclosure have been described primarily with respect to use with a high school student looking for a scholarship or position on a collegiate level athletic team. Athletes associated with any number of different types of athletic events, and the related collegiate teams, may benefit from the embodiments disclosed herein. For instance, example sports where scholarship or collegiate positions may be available include men's and women's sports. Example sports include baseball, basketball, bowling, cheerleading, cricket, cross country, fencing, field hockey, football, golf, gymnastics, ice hockey, lacrosse, rifle shooting, rowing, rugby, skiing, soccer, softball, swimming and diving, tennis, track and field, volleyball, water polo, and wrestling. Embodiments are not, however, limited to sports or collegiate activities. For instance, in other embodiments, recruiting may take place at a collegiate or other level for dance teams, bands, choirs, orchestras, debate teams, drama troupes, art, quiz bowl, or other types of endeavors. Embodiments of the present disclosure may also be used in connection with such activities. Further, participants in extreme sports, mixed martial arts, or other activities which may not have corresponding collegiate or academic followings may benefit from embodiments of the present disclosure. For instance, a skateboarder may use the systems, methods, interfaces, applications, and the like disclosed herein to contact a recruiter such as an event sponsor.

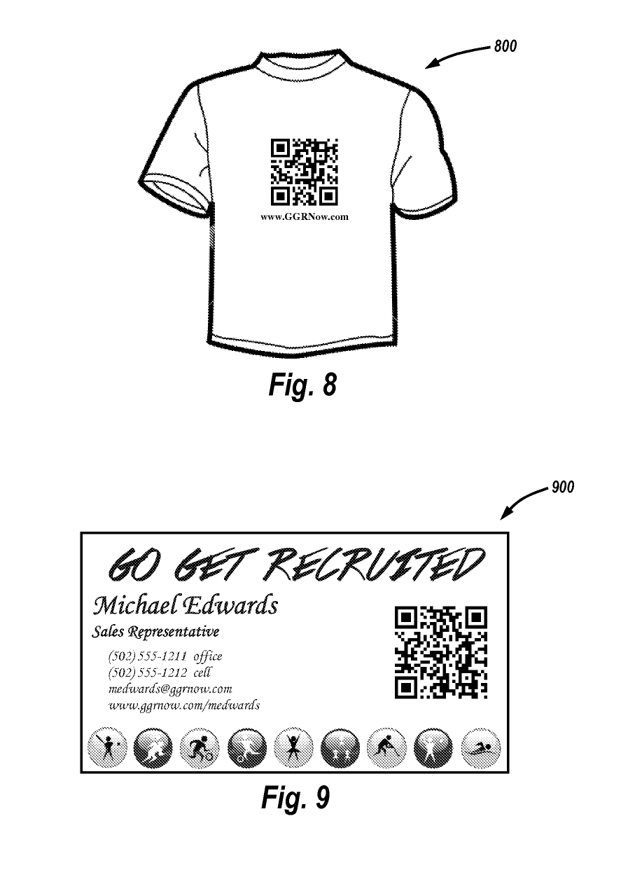

Some embodiments of the present disclosure may also relate to methods and systems for marketing, and more particularly to marketing self-recruiting or full service recruiting services to students, athletes, or other people. FIG. 8, for instance, illustrates an example shirt 800 on which a QR code is displayed. In this embodiment, the QR code is displayed on a front of the shirt 800, but could additionally, or alternatively, be displayed on a sleeve, back side, or other location on the shirt 800. Such a QR code could also be displayed on other articles of clothing including hats, pants, ties, coats, jackets, or the like. In still other embodiments, the QR code could be displayed on other objects, such as backpacks, bags, water bottles, sports equipment, promotional items (e.g., stress balls, golf balls, umbrellas, pens, cozies, notepads, etc.). Optionally, text or other indicia (e.g., a web address) may also be displayed. Such text or other elements are, however, merely optional in some embodiments. In a marketing context, the QR code may be scanned by a mobile device or other device, which may then interpret the QR code and direct the user to an appropriate web address or other location. Textual information, such as a webpage, may also provide a similar use when typed into a browser by a user. Of course, in other embodiments, other types of codes may be provided. Illustrative examples may include launch points such as snap tags, MICROSOFT tags, images associated with BLIPPAR and/or SMARTSY, invisible text used by TOUCHCODE, and the like.

In the context of a recruiting service, such as that described herein, the shirt 800 in FIG. 8 may be worn by any number of people, including employees, sales representatives, executives, independent contractors, or others. A sales representative for a recruiting company (e.g., a recruiting company providing the services such as those described with respect to any or all of FIGS. 1-7), may wear the shirt 800. A person hearing wondering about the QR code or other launch point, or hearing about the company, may then simply scan the QR code or other presented data to obtain information, even without an electronic or physical business card or other type of personal information. The QR code or other launch point may direct the person to a main web page associated with a recruiting company, or to another location. For instance, if the recruiting company has a website at http://www.GGRnow.com, the QR code or other launch point may also direct a person to that website.

In another embodiment, a sales representative may receive commissions or other compensation based on referrals to a website. In such an embodiment, the QR code or other launch point may direct a user to a web site associated with that sales representative, so that the sales representative may be identified as the origin of the interest in the company. The website for the sales representative may be a different page specifically identifying the representative. In other embodiments, there may be a re-direct associated with the page so that the access request may be associated with a representative's particular page, but the access may be re-directed to the main page, or a page similar to the main page, of a website.

Of course, QR codes and other launch points on clothing, backpacks, and other items may be used in other manners. For instance, as part of a recruiting package, or as an add-on, a recruitable athlete may be provided a shirt 800 or other object with a QR code or similar launch point. The QR code or other launch point for the athlete may be associated with the student's own personalized website. The athlete may then wear the shirt while speaking with recruiters or at other times, and people may scan the image to access the student's highlight films, interests, or other information.

In addition to, or instead of, using clothing, backpacks, and the like with QR codes and launch points thereon, a business card or other similar element may also be provided and used in a similar manner. FIG. 9, for instance, illustrates an example business card 900 for a sales representative. The business card 900 may include a QR code, website address, launch point, or other information that can be used to access a website. An address may additionally, or alternatively, be provided for downloading an application in a mobile app store. Such links may operate in a manner similar to that discussed herein. For instance, a code, a link, or address may be associated with a home page of a website associated with a service provider (e.g., http://www.GGRNow.com). In other embodiments, a link, code, or other address may be associated with a different page. For instance, the illustrated business card 900 may include an address and/or QR code (or other launch point or linking element) that may be associated with a webpage for a particular sales representative (e.g., http://www.GGRNow.com/medwards). If a person goes to such an address, the sales representative may be given credit as the originator of any purchases then made by a visitor. When the user accesses the website, the user may or may not know it is particularly associated with the sales representative. This may be particularly the case as the website associated with the sales representative may look identical, or nearly identical, to a home page, or may even have a re-direct to send the user to the home page, while also tracking the origin through the sales representative's page.

Embodiments of the present disclosure may therefore include any number of features, components, and aspects. Nothing herein should be interpreted as limiting the scope of the present disclosure to any particular embodiment described or illustrated. Rather, each embodiment may include any combination of features described or understood in view of the disclosure herein.

Moreover, embodiments of the present disclosure may be used in connection with various end-user devices. For instance, web pages, applications, interfaces, and the like may be used with a number of types of suitable electronic devices. Examples of suitable electronic devices may include cell phones, smart phones, personal digital assistants (PDAs), tablet computing devices, netbooks, e-readers, laptop computers, desktop computers, media players, global positioning system (GPS) devices, servers, other devices capable of reading data from a local data store or communicating data over a data network, or any combination of the foregoing. In at least one embodiment, a network may be capable of carrying electronic communications. The Internet, local area networks, wide area networks, virtual private networks (VPN), telephone networks, other communication networks or channels, or any combination of the forgoing may thus be represented by a network.

The network and devices connected thereto may operate in a number of different manners. Different manners of operation may be based at least in part on a type of the network or a type of connection to the network. For instance, various components of a system may include hard-wired communication components and/or wireless communication components or interfaces (e.g., 802.11, Bluetooth, CDMA, LTE, GSM, HSPA+, etc.). Moreover, the network may include multiple networks interconnected to facilitate communication between one or more electronic devices or systems.

Embodiments of the present disclosure may generally be performed by a computing device, and more particularly performed in response to instructions provided by an application, process, web page, or component executing on the computing device or within a computing system. Hardware, firmware, software, or any combination of the foregoing may be used in directing the operation of a computing device or system. Embodiments of the present disclosure may thus comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures, including applications, tables, or other modules used to execute particular functions or direct selection or execution of other modules. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “network”, “data network”, or “communication network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, servers, and the like. Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices. Cloud-based, or software-as-a-service systems are also examples of a distributed environment which may be used in connection with embodiments of the present disclosure.

Although the foregoing description contains many specifics, these should not be construed as limiting the scope of the invention or of any of the appended claims, but merely as providing information pertinent to some specific embodiments that may fall within the scopes of the invention and the appended claims. Various embodiments are described, some of which incorporate differing features. The features illustrated or described relative to one embodiment are interchangeable and/or may be employed in combination with features of any other embodiment herein. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A method for a third party to facilitate recruiting of a recruit by a potential recruiter, and without acting as an intermediary, the method comprising:
electronically providing a recruiting package of information to a recruit, the recruiting package of information including comprising:
contact information for one or more potential recruiters; and
instructional information on preparing recruiting-related information to be sent directly by the recruit to the one or more potential recruiters using the contact information; and
providing a mobile application for download by the recruit, wherein the mobile application comprises a user interface to provide feedback information regarding which of the one or more potential recruiters have viewed recruiting-related information of the recruit.

2. The method of claim 1, further comprising:
receiving, at a provider computing system, the recruiting-related information of the recruit;
hosting, by the provider computing system, the recruiting-related information sent directly by the recruit to the one or more potential recruiters by the recruit;
tracking, by the provider computing system, access of the recruiting-related information of the recruit by the one or more potential recruiters, the recruiting-related information having been provided to the one or more potential recruiters directly by the recruit; and
notifying, by the provider computing system, the recruit of the access by the one or more potential recruiters via the mobile application when the one or more potential recruiters view the recruiting-related information of the recruit hosted at the provider computing system.

3-23. (canceled)

24. The method of claim 1 further comprising:
receiving, via the mobile application, the recruiting-related information from the recruit; and
providing the recruiting-related information directly to the one or more potential recruiters, wherein the recruiting-related information comprises a hyperlink that, when activated by the one or more potential recruiters, directs the one or more potential recruiters to the recruiting-related information that is hosted by the provider computing system.

25. The method of claim 24, wherein the recruiting-related information includes any combination of one or more of:
physical characteristics of the recruit;
sports played by the recruit;
scholastic information of the recruit; or contact information of the recruit.

26. The method of claim 24 further comprising:
receiving a recruiter request from one of the one or more potential recruiters to access the recruiting-related information using the hyperlink; and
sending a notification of the recruiter request to the recruit via the user interface.

27. The method of claim 1, wherein the recruiting-related information comprises at least one of a highlight video, or a hyperlink to the highlight video.

28. The method of claim 1 further comprising:
notifying the recruit of a location of a request to access the recruiting-related information via the user interface, wherein the location is a geographic location or a school.

29. The method of claim 1, wherein the recruiting-related information is provided directly to the one or more potential recruiters via a recruiter interface, the method further comprising:
receiving, via the recruiter interface from the potential recruiter, a request for further information of the recruit; and
requesting the further information from the recruit via the user interface or in an email to the recruit.

30. A system comprising:
a memory; and
a processor operatively coupled to the memory, the processor to:
electronically provide a recruiting package of information to a recruit, the recruiting package of information comprising:
contact information for one or more potential recruiters; and
instructional information on preparing recruiting-related information to be sent directly by the recruit to the one or more potential recruiters using the contact information; and
provide a mobile application for download by the recruit, wherein the mobile application comprises a user interface to provide feedback information regarding which of the one or more potential recruiters have viewed recruiting-related information of the recruit.

31. The system of claim 30, the processor further to:
receive, at a provider computing system, the recruiting-related information of the recruit;
host, by the provider computing system, the recruiting-related information sent directly by the recruit to the one or more potential recruiters by the recruit;
tracking, by the provider computing system, access of the recruiting-related information of the recruit by the one or more potential recruiters, the recruiting-related information having been provided to the one or more potential recruiters directly by the recruit; and
notify, by the provider computing system, the recruit of the access by the one or more potential recruiters via the mobile application when the one or more potential recruiters view the recruiting-related information of the recruit hosted at the provider computing system.

32. The system of claim 31, the processor further to:
receive, via the mobile application, the recruiting-related information from the recruit; and
provide the recruiting-related information directly to the one or more potential recruiters, wherein the recruiting-related information comprises a hyperlink that, when activated by the one or more potential recruiters, directs the one or more potential recruiters to the recruiting-related information that is hosted by the provider computing system.

33. The system of claim 32, the processor further to:
receive a recruiter request from one of the one or more potential recruiters to access the recruiting-related information using the hyperlink; and
send a notification of the recruiter request to the recruit via the user interface.

34. The system of claim 30, wherein the recruiting-related information comprises at least one of a highlight video, or a hyperlink to the highlight video.

35. The system of claim 30 further comprising:
notify the recruit of a location of a request to access the recruiting-related information via the user interface, wherein the location is a geographic location or a school.

36. The system of claim 30 wherein the recruiting-related information is provided directly to the one or more potential recruiters via a recruiter interface, the processor further to:
receive, via the recruiter interface from the potential recruiter, a request for further information of the recruit; and
request the further information from the recruit via the user interface or in an email to the recruit.

37. A non-transitory, computer readable storage medium that comprises operations that, when executed by a processor, cause the processor to perform operations for a third party to facilitate recruiting of a recruit by a potential recruiter, and without acting as an intermediary, the operations comprising:
electronically providing recruiting information to a recruit, the recruiting information comprising:
contact information for one or more potential recruiters; and
information on preparing recruiting-related information to be sent directly by the recruit to the one or more potential recruiters using the contact information; and
providing a mobile application for download by the recruit, wherein the mobile application comprises a user interface to provide feedback information regarding which of the one or more potential recruiters have viewed recruiting-related information of the recruit.

38. The non-transitory, computer readable storage medium of claim 37, the operations further comprising:
receiving, at a provider computing system, the recruiting-related information of the recruit;
hosting, by the provider computing system, the recruiting-related information sent directly by the recruit to the one or more potential recruiters by the recruit;
tracking, by the provider computing system, access of the recruiting-related information of the recruit by the one or more potential recruiters, the recruiting-related information having been provided to the one or more potential recruiters directly by the recruit; and
notifying, by the provider computing system, the recruit of the access by the one or more potential recruiters via the mobile application when the one or more potential recruiters view the recruiting-related information of the recruit hosted at the provider computing system.

39. The non-transitory, computer readable storage medium of claim 38, the operations further comprising:
receiving, via the mobile application, the recruiting-related information from the recruit; and
providing the recruiting-related information directly to the one or more potential recruiters, wherein the recruiting-related information comprises a hyperlink that, when activated by the one or more potential recruiters, directs the one or more potential recruiters to the recruiting-related information that is hosted by the provider computing system.

40. The non-transitory, computer readable storage medium of claim 38, the operations further comprising:
receiving a recruiter request from one of the one or more potential recruiters to access the recruiting-related information using the hyperlink; and
sending a notification of the recruiter request to the recruit via the user interface.

41. The non-transitory, computer readable storage medium of claim 37, wherein the recruiting-related information is provided directly to the one or more potential recruiters via a recruiter interface, the operations further comprising:
receiving, via the recruiter interface from the potential recruiter, a request for further information of the recruit; and
requesting the further information from the recruit via the user interface or in an email to the recruit.
